(19) United States
(12) Patent Application Publication
(10) Pub. No.: US 2017/0295780 A1
(43) Pub. Date: Oct. 19, 2017

(54) Humidity-dependent antibacterial laminate

(71) Applicant: Food Industry Research and Development Institute, Hsinchu (TW)

(72) Inventors: Yu-Chi CHENG, Hsinchu (TW); Hsiang-Ru LI, Hsinchu (TW); Wei-Lun LEE, Hsinchu (TW); Ying-Cheng LEE, Hsinchu (TW); Binghuei Barry YANG, Hsinchu (TW)

(21) Appl. No.: 15/183,912

(22) Filed: Jun. 16, 2016

(30) Foreign Application Priority Data
Apr. 14, 2016 (TW) 105111710

(51) Int. Cl. A01N 25/10

(52) U.S. Cl. CPC A01N 25/10

(57) ABSTRACT

A laminate including a substrate, an antibacterial agent-containing layer on a surface of the substrate, and a moisture triggering layer on the antibacterial agent-containing layer is provided, wherein the antibacterial agent-containing layer contains a volatile antibacterial agent, and the moisture triggering layer contains a hydrophilic polymer such as polyvinylpyrrolidone. The laminate releases a relatively larger amount of anti-bacterial agent in vapor form in a humid environment in comparison with a dry environment.

### FIELD OF THE INVENTION

The present invention relates to a humidity-dependent antibacterial laminate and fabrication method thereof.

### BACKGROUND OF THE INVENTION

A humidity-dependent antibacterial powdery composition, process for producing the same, humidity-dependent antibacterial food storing article and method of storing food is disclosed in Taiwan Patent 357309 (which is equivalent to U.S. Pat. No. 7,923,035 B2 and JP 4683925 B2). Said humidity-dependent antibacterial powdery composition comprises a volatile oily antibacterial substance, a water-soluble film forming agent and selective powder excipients, and the behavior of changing the release of the aforesaid antibacterial substance according to humidity. Said water-soluble film forming agent is used to form moisture-absorptive capsule particles with a volatile oily antibacterial substance inside, and releases said volatile oily antibacterial substance once humidity reaches a certain level or above. This agent can be made from any substance, and may specifically be gum arabic, gelatine, semi-cellulose, microbially generated polysaccharides and modified starch. The powder excipients suitable for use may be non moisture-absorptive starch or dextrin. In Example 1 thereof, said humidity-dependent antibacterial powdery composition was evenly mixed with an acrylic binder, and then the resultant mixture was coated on a surface of a non-woven fabric by using a roller; this was followed by pressing the coated surface with an iron heated to 120° C. to dry it, thereby producing an antibacterial film having a coating with humidity-dependent antibacterial powdery composition evenly dispersed therein. In Example 2 thereof, 20% by weight of the humidity-dependent antibacterial powdery composition made in Example 1 was evenly mixed with a polyethylene resin, so as to produce an antibacterial master batch. Subsequently, 5% of the antibacterial master batch was evenly mixed with a polyethylene resin and then subjected to inflation film process, in order to produce an antibacterial polyethylene bag (20×30 cm) with humidity-dependent antibacterial powdery composition evenly dispersed therein, and with a thickness of 60 μm. From the above-mentioned examples, it is noted that the powder excipients and the step of forming powdery composition will be saved, if the volatile oily antibacterial substance can be directly applied to produce the antibacterial film and the antibacterial polyethylene bag.

### SUMMARY OF THE INVENTION

It is therefore the primary object of the present invention to provide a humidity-dependent antibacterial laminate without the aforesaid drawbacks of the prior art.

Another object of this invention is to provide a fabrication method for a humidity-dependent antibacterial laminate without the aforesaid drawbacks of the prior art.

A further object of this invention is to provide a use of a humidity-dependent antibacterial laminate in storing food.

To achieve the above-mentioned objects of the present invention, a laminate constructed in accordance with the invention comprises a substrate, an antibacterial agent-containing layer being coated and dried on a surface of said substrate, and a moisture triggering layer being coated and dried on said antibacterial agent-containing layer, wherein said antibacterial agent-containing layer contains a volatile antibacterial agent; said moisture triggering layer contains a hydrophilic polymer, and said antibacterial agent and said hydrophilic polymer are not mixed together. The laminate of the invention releases a relatively large amount of said volatile antibacterial agent in vapor form in a humid environment in comparison with a dry environment, therefore possessing the behavior of releasing depending on humidity. Unexpectedly, the inventors of this invention discovered that when only a single layer is coated on said substrate, wherein both the antibacterial agent and hydrophilic polymer are mixed and included in the single layer, said substrate coated with the single layer loses the humidity dependent releasing behavior.

Preferably, said hydrophilic polymer is polyvinylpyrrolidone.

Preferably, said antibacterial agent-containing layer further comprises a binder resin.

Preferably, said moisture triggering layer further comprises a binder resin.

Preferably, said binder resin is a homopolymer of acrylic or acrylate monomer, or a copolymer of acrylic, acrylate, or acrylic and acrylate monomers.

Preferably said substrate is plastic, paper, fabric or non-woven fabric.

Preferably, said dried moisture triggering layer has a measured thickness of 1-10 μm, and said dried antibacterial agent-containing layer has a measured thickness of 1-10 μm.

### DETAILED DESCRIPTION OF PREFERRED EMBODIMENTS

The commercial volatile antibacterial packing materials suffer a drawback, which is they have to be used up within a certain period of time, so as to ensure that at the time of being used by food plants or consumers, said antibacterial packing materials still possess a desired concentration of released antibacterial agent. To solve this drawback, in a preferred embodiment of the present invention, an antibacterial sheet is fabricated by employing a moisture triggering formula and a double-coated fabric. The fabricated antibacterial sheet has a glassy surface which releases a low amount of antibacterial agent (bacteria inhibiting ingredient) under low humidity. After said antibacterial sheet is packed with foods in an enclosed space, the moisture from the foods triggers the release of the bacteria inhibiting ingredient from said antibacterial sheet.

The moisture triggering formula mainly includes an antibacterial agent, a coating agent (which includes a binder resin) and a polymer with the capability of forming hydrogen bonds (hydrophilic polymer). Suitable antibacterial agents should be volatile and may be selected from the essential oils of chilli pepper, garlic, Japanese horseradish, canola oil, rosemary, mint, cinnamon, star anise, thyme and cypress, or previously known bacteria inhibiting or bacteria killing ingredients such as acetic acid, propionic acid, ethanol, sulfur dioxide and chlorine dioxide, or a mixture thereof.

A suitable fabrication method for producing the humidity-dependent antibacterial laminate of the present invention comprises the steps of firstly mixing together said antibacterial agent, said coating agent and selectively an emulsifier, and then coating the mixture on a substrate, followed by drying and further coating of a mixed solution made from mixing a coating agent with a hydrophilic polymer, and finally resulting in a laminate having a three-layered structure constituted of a substrate, an antibacterial agent-containing layer and a moisture triggering layer after drying. Said coating step may be carried out by any of the prior art methods, such as blade coating, spin coating, spray coating, printing or dip coating.

Said coating agent may be an aqueous or oily coating agent, and is preferably an aqueous coating agent. A suitable example of said coating agent includes (but not limited to) a coating material, a varnish, an emulsified wax and an ink.

When said coating agent aqueous coating agent, such as aqueous coating material of an acrylic resin type, and said antibacterial agent is of oily type, said emulsifier is used to form an emulsion of said antibacterial agent and said coating agent. A suitable example of said coating agent can be found in the above-mentioned Taiwan Patent 357309 (which is equivalent to U.S. Pat. No. 7,923,035 132 B2 and JP 4683925 B2).

Said substrate may be paper or plastic, wherein the plastic can be PET (Polyethylene terephthalate), VMPET (Vaccum metallized PET), PP (Polypropylene), PE (Polyethylene) and EVOH (Ethylene-vinyl alcohol compolymer), without any specific limitations.

Said hydrophilic polymer may be a polymer having hydrogen bonds, such as polyvinylpyrrolidone, polyvinyl alcohol, EVOH or natural polymers. The moisture triggering effect is achieved via hydration by hydrogen bonding. Preferably, said hydrophilic polymer is polyvinylpyrrolidone. More preferably, said hydrophilic polymer is polyvinylpyrrolidone with a weight-average molecular weight of 10,000 Dalton.

### Embodiment 1

### 1-1: Fabricating a Moisture Triggering Antibacterial Sheet

16 g of mint essential oil and 5 g of emulsifier (lecithin, Gemfont Corporation, Taipei City, Taiwan) were added to 84 g of aqueous acrylic coating material (3RCHEM Co., LTD., Taipei City, Taiwan; coded W-6203D8M), which were homogenized for 5 minutes and vacuum degassed to prepare a Formula A. 10 g of polyvinylpyrrolidone aqueous solution (Sigma-Aldrich, PVP10) was added to and stirred at 400 rpm until fully miscible with 33 g of aqueous acrylic coating material (3RCHEM Co., LTD., W-6203D8M) to prepare a Formula B.

An adequate amount of Formula A was obtained and coated on a PET film by using No. 6 wire-wound rod, then dried in an oven at 100° C. for 20 seconds. Subsequently, an adequate amount of Formula B was obtained and coated as the second layer of coating on the dried coating of the Formula A on the PET film by using No. 6 wire-wound rod. A moisture triggering antibacterial sheet was obtained once the coatings were hardened and dried by heating. The wet film thickness obtained from coating by No. 6 wire-wound rod is 15.2 μm; the theoretical thickness obtained after the first layer was dried is 8.6 μm, and the actual measured thickness is 3 μm (Formula A); the theoretical thickness obtained after the second layer was dried is 8.9 μm, and the actual measured thickness is 2 μm (Formula B); the total theoretical thickness is 17.5 μm.

### 1-2: Testing the Release of the Antibacterial Sheet

The antibacterial sheet fabricated in step 1-1 was cut into pieces of the size of 7*9 cm², and placed and sealed in 1 L aluminum foil airtight bags with sampling holes, together with saturated salt solutions having different humidity adjustments, and then left in a thermostatic oven at 30° C. Gaseous samples were taken from the upper space in the bag via the sampling hole at different period of time intervals, and then the concentrations of the essential oil of the gaseous samples in the bags under different humidities were analyzed and recorded by using the gas chromatograph.

### Embodiment 2

### 2-1: Fabricating a Moisture Triggering Antibacterial Paper

Basing on the method described in step 1-1, an adequate amount of Formula A was obtained and coated on a piece of paper by using No. 6 wire-wound rod, then dried in an oven at 100° C. for 20 seconds. Subsequently an adequate amount of Formula B was obtained and coated as the second layer of coating on the dried Formula A coating of the piece of paper, by using No. 6 wire-wound rod. The paper was then heated to allow for setting arid drying, so as to obtain a moisture triggering antibacterial paper card. The wet film thickness obtained from coating by No. 6 wire-wound rod is 15.2 μm; the theoretical thickness obtained after the first layer was dried is 8.6 μm (Formula A); the theoretical thickness obtained after the second layer was dried is 8.9 μm (Formula B); the total theoretical thickness is 17.5 μm.

### 2-2: Testing the Release of the Antibacterial Paper

The antibacterial paper fabricated in step 2-1 were cut into pieces of the size of 7*9 cm², and then tested according to the method described in step 1-2.

TABLE 1
concentrations (ppb) released from moisture triggering
antibacterial sheets under different levels of humidity

| Humidity | Embodiment 1 | | | Embodiment 2 | |
|---|---|---|---|---|---|
| Time | 50% | 72% | 100% | 50% | 100% |
| 1 day | 0.08 | 0.67 | 3.33 | 2.00 | 3.13 |
| 3 days | 0.03 | 0.28 | 3.29 | 2.04 | 3.47 |
| 7 days | 0.01 | 0.15 | 2.95 | 2.99 | 4.49 |

### Comparison 1

16 g of mint essential oil was added to and homogenized for 5 minutes and vacuum degassed with 84 g of aqueous acrylic coating material, and coated on a PET film by using No. 6 wire-wound rod, then placed and dried in an oven at 100° C. for 20 seconds, thereby resulting in Comparison 1. (The wet film thickness obtained from coating by No. 6 wire-wound rod is 15.2 μm; the theoretical thickness obtained after drying is 7.9 μm, and the actual measured thickness is 3 μm).

### Comparison 2

16 g of mint essential oil, 5 g of emulsifier and 10 g of polyvinylpyrrolidone were added to and homogenized for 5 minutes and vacuum degassed with 84 g of aqueous acrylic coating material, and coated on a PET film by using No. 6 wire-wound rod, then placed and dried in an oven at 100° C. for 20 seconds, thereby resulting in Comparison 2. (The wet film thickness obtained from coating by No. 6 wire-wound rod is 15.2 μm; the theoretical thickness obtained after drying is 9.2 μm, and the actual measured thickness is 3 μm).

TABLE 2
concentrations (ppb) released from moisture triggering antibacterial sheets
under different levels of humidity

| | |
|---|---|
| Comparison 1 | Comparison 2 |

Humidity

| Time | 50% | 72% | 100% | 50% | 72% | 100% |
|---|---|---|---|---|---|---|
| 1 day | 1.30 | 0.87 | 1.19 | 0.69 | 1.05 | 1.75 |
| 3 days | 1.35 | 1.11 | 1.07 | 0.85 | 1.06 | 1.00 |
| 7 days | 1.19 | 0.70 | 0.77 | 0.97 | 1.16 | 1.10 |

From the data in Tables 1 and 2, it can he seen that under 100% humidity, the humidity triggering antibacterial sheets from Embodiments 1 and 2 of the present invention released significantly higher concentrations of antibacterial agent than. those under 50% humidity. In contrast, the antibacterial sheets from Comparisons 1 and 2 did not exhibit the same performance. When all of the substrates of the antibacterial sheets were PET films, the antibacterial sheets from Embodiment 1 of the invention and Comparisons 1 and 2 also behaved differently under 50% humidity; the antibacterial sheet from Embodiment 1 of the invention released significantly lower concentration of antibacterial agent than that of Comparisons 1 and 2, which indicates the moisture triggering antibacterial sheet from Embodiment 1 of the invention can be preserved for longer time under 50% humidity.

What is claimed is:

1. A laminate comprising a substrate, an antibacterial agent-containing layer being coated and dried on a surface of said substrate, and a moisture triggering layer being coated and dried on said antibacterial agent-containing layer, wherein said antibacterial agent-containing layer comprises a volatile antibacterial agent, and said moisture triggering layer comprises a hydrophilic polymer, and said antibacterial agent and said hydrophilic polymer are mixed together, wherein said laminate releases a relatively larger amount of said volatile antibacterial agent in gaseous form in a humid environment in comparison to a dry environment.

2. The laminate of claim 1, wherein said hydrophilic polymer is polyvinylpyrrolidone.

3. The laminate of claim 1, wherein said antibacterial agent-containing layer further comprises a binder resin.

4. The laminate of claim 1, wherein said moisture triggering layer further comprises a binder resin.

5. The laminate of claim 3, wherein said binder resin is a homopolymer of acrylic or acrylate monomer, or a copolymer of acrylic, acrylate, or acrylic and acrylate monomers.

6. The laminate of claim 4, wherein said binder resin is a homopolymer of acrylic or acrylate monomer, or a copolymer of acrylic, acrylate, or acrylic and acrylate monomers.

7. The laminate of claim 1, wherein said substrate is plastic, paper, fabric or non-woven fabric.

8. The laminate of claim 1, wherein said dried moisture triggering layer has a measured thickness of 1-10 μm, and said dried antibacterial agent-containing layer has a measured thickness of 1-10 μm.
